(19) United States
(12) Patent Application Publication
(10) Pub. No.: US 2009/0177456 A1
(43) Pub. Date: Jul. 9, 2009

(54) Mixed Decoupled Electromagnetic Circuit Solver

(75) Inventors: Vikram Jandhyala, Seattle, WA (US); Swagato Chakraborty, Kirland, WA (US); Dipanjan Gope, Kirkland, WA (US); Feng Ling, Issaquah, WA (US)

Correspondence Address: THE WEBB LAW FIRM, P.C., 700 KOPPERS BUILDING, 436 SEVENTH AVENUE, PITTSBURGH, PA, 15219, US

(73) Assignee: PHYSWARE, INC., Bellevue, WA (US)

(21) Appl. No.: 11/968,698

(22) Filed: Jan. 3, 2008

(51) Int. Cl. G06F 17/50

(52) U.S. Cl. 703/14

(57) ABSTRACT

In a method, system and computer readable medium for determining a composite circuit model of a 3D geometry, first and second sides of an analytical model of the 3D geometry are discretize into first and second surface and/or volume meshes. For each mesh, a current that flows in each cell thereof and the a voltage induced in the cell in response to the application of an exemplary bias to the geometry are determined. For each mesh, from the currents flowing in the cells thereof and voltages induced in the cells thereof, a corresponding circuit model is determined. The circuit models of the meshes are then combined to form a composite circuit model for the geometry.

### BACKGROUND OF THE INVENTION

1. Field of the Invention

The present invention relates to the modeling of electrical circuit elements or objects and, more particularly, to electromagnetic modeling of such elements.

2. Description of Related Art

Stimulating the electrical behavior of objects or elements, especially electromagnetic behavior, requires numerical/computational techniques, such as the finite element method, finite difference method, or the so-called method of moments (MOM) method. These methods solve Maxwell's equations for these elements. In electronics such structures include IC packages, circuit boards, integrated circuit chips, connectors, etc. More generally, these objects or elements can be structures such as aircrafts, automobiles, antennas, humans, biological systems, etc.

In these electromagnetic modeling methods, the response that objects or elements have to excitation(s), such as incident waves or currents that excite these elements is determined. In the first step of such modeling, the entire surface of the element is broken up into simple mesh elements, such as, small triangles or rectangles, and/or the entire volume of the element is broken up into volumetric elements, such as bricks, tetrahedra, or prisms. Such a step, routinely done in these techniques, is called mesh generation or surface/volume tessellation.

The purpose of this meshing is to discretize equations on each cell of the mesh and to approximately solve these equations on the mesh, by converting Maxwell's equations to a matrix equation, commonly known as the method of moments (MOM) method.

The matrix system associated with the MOM can be a large, dense system. The storage of such a matrix system takes computer memory that scales as the square of N (i.e., N²), where the dimension of the matrix is N×N. The solution of this matrix utilizing standard inversion/solution methods takes time/CPU units proportional to the cube of N (i.e., N³). For larger matrices, it is sometimes beneficial to use iterative methods where, starting with an initial guess of the solution, successively improved guesses are made by a variety of techniques until the solution finally converges to an answer. The cost in time of such a procedure is related to the cost of multiplying a matrix times a vector (which scales as the square of N) times the number of iterations. The number of iterations can be kept smaller than N by using a class of techniques called preconditioning, which keeps the total cost in time of the iterative solution proportional to the square of N (as compared to the cube of N). This can cause dramatic speedups for large N (which could be as large as six or seven digits for large electromagnetic problems).

What would, therefore, be desirable are a method, system and computer readable medium that enables solutions of electromagnetic problems that avoid the use of large matrices and the accompanying computational time to solve such matrices.

The following documents disclose background art that is useful for an understanding of the present invention:
“A Precorrected-FFT Method For Electrostatic Analysis of Complicated 3-D Structures”; IEEE Transactions On Computer-Aided Designs of Integrated Circuits And Systems, Vol. 16, No. 10, October 1997; (pages 1059-1072); Joel R. Phillips et al.;
“Generalized Kirchoff's Current And Voltage Law Formulation For Coupled Circuit-Electromagnetic Simulation With Surface Integral Equations”; IEEE Transactions On Microwave Theory And Techniques, Vol. 52, No. 7, July 2004; (pages 1673-1682); Yong Wang et al.;
“Electromagnetic Scattering By Surfaces Of Arbitrary Shape”; IEEE Transactions On Antennas And Propagation, Vol. AP-30, No. 3, May 1982; (pages 409-418); Sadasiva M. Rao et al.;
“A Surface Equivalence-Based Method To Enable Rapid Design And Layout Iterations Of Coupled Electromagnetic Components In Integrated Packages”; IEEE 2004; (pages 45-48); Swagato Chakraborty et al.;
“Multilevel Fast Multipole Algorithm For Electromagnetic Scattering By Large Complex Objects”; IEEE Transactions On Antennas And Propagation, Vol. 45, No. 10, October 1997; (pages 1488-1493); Jiming Song et al.;
“The Adaptive Cross Approximation Algorithm For Accelerated Method Of Moments Computations Of EMC Problems”; IEEE Transactions On Electromagnetic Compatability, Vol. 47, No. 4, November 2005; (pages 763-773); Kezhong Zhao et al.; and S-Parameter Techniques For Faster, More Accurate Network Design; Test & Measurement Application Note 95-1; http://www.hp.com/go/tmappnotes (79 pages).

### SUMMARY OF THE INVENTION

One embodiment of the invention is a method of determining a composite circuit model of a 3D geometry. The method includes (a) discretizing first and second sides of an analytical model of a 3D geometry into first and second surface and/or volume meshes; (b) determining for each mesh a current that flows in each cell thereof in response to the application of an exemplary bias to the geometry; (c) determining for each mesh a voltage induced in each cell thereof in response to the application of the exemplary bias to the geometry; (d) for each mesh, determining from the currents flowing in the cells thereof and the voltages induced in the cells thereof a corresponding circuit model; and (e) coupling the circuit models of the meshes to form a composite circuit model for the geometry.

The circuit model for each mesh can be determined via either a direct simulation technique or an iterative solution technique. The direct simulation technique includes inverting a matrix of the currents flowing and the voltages induced in the cells of the mesh. The iterative solution technique includes iteratively determining a solution for x in the equation Ax=b, where A is a matrix determined from the currents flowing and the voltages induced in the cells of the mesh and b is an (n×1) vector of the voltages determined for each cell of the mesh in step (c).

The matrix of the direct simulation technique can be determined via a method of moments technique. The matrix A of the iterative solution technique can be determined via either: (1) the method of moments technique; or (2) a compressed version of matrix a matrix determined via the method of moments technique. The compressed version of the matrix can be determined via: a fast multipole technique; a singular value decomposition technique; a QR decomposition technique; an adaptive cross approximation technique; a fast Fourier transform technique; a wavelet technique; or some combination of two or more thereof.

Each circuit model can be an S-parameter circuit model.

When the geometry includes an aperture therethrough, step (a) further includes discretizing the first and second sides of the analytical model of the geometry into third and fourth surface and/or a volume meshes each of which includes no cells at a location thereof corresponding to the location of the aperture in the geometry.

Step (d) can further include, for the combination of the third and fourth meshes, determining from the currents flowing in the cells thereof and the voltages induced in the cells thereof in response to the application of the exemplary bias to the geometry a corresponding circuit model. Step (e) can further include coupling the circuit model for the combination of the third and fourth meshes with the circuit models of the first and second meshes to form the composite terminal circuit model for the geometry.

The geometry can include a conductor disposed through the aperture in spaced, non-contacting relation. The first mesh can include a subset of cells for that portion of the conductor that extends in a direction opposite the second side. The second mesh can include a subset of cells for that portion of the conductor that extends in a direction opposite the first side. The third mesh can include a subset of cells for that portion of the conductor that resides in the aperture. The fourth mesh incan include includes a subset of cells for that portion of the conductor that resides in the aperture.

Each circuit model can be an S-parameter circuit model.

Another embodiment of the invention is a system for determining a composite circuit model of a 3D geometry. The system includes: means for discretizing first and second sides of an analytical model of a 3D geometry into first and second surface and/or volume meshes; means for determining for each mesh a current that flows in each cell thereof in response to the application of an exemplary bias to the geometry; means for determining for each mesh a voltage induced in each cell thereof in response to the application of the exemplary bias to the geometry; means for determining for each mesh from the currents flowing in the cells thereof and the voltages induced in the cells thereof a corresponding circuit model; and means for coupling the circuit models of the first and second meshes to form a composite circuit model for the geometry.

The circuit model for each mesh can be determined via either: a direct simulation technique that includes inverting a matrix of the currents flowing and the voltages induced in the cells of the mesh; or an iterative solution technique that includes iteratively solving the equation Ax=b for x, wherein A is a matrix determined from the currents flowing and the voltages induced in the cells of the mesh and b is an (n×1) vector of the voltages determined for each cell of the mesh in step (c).

The matrix of the direct simulation technique can be determined via a method of moments technique. The matrix A of the iterative solution technique can be determined via either: (1) the method of moments technique; or (2) a compressed version of a matrix determined via the method of moments technique.

The compressed version of the matrix can be determined via: a fast multipole technique; a singular value decomposition technique; a QR decomposition technique; an adaptive cross approximation technique; a fast Fourier transform technique; a wavelet technique; or some combination of two or more thereof.

Each circuit model can be an S-parameter circuit model.

The geometry can include an aperture therethrough, the means for discretizing discretizes the first and second sides of the analytical model of the geometry into third and fourth surface and/or a volume meshes, each of which includes no cells at a location thereof corresponding to the location of the aperture in the geometry.

The means for determining can determine a circuit model for the combination of the third and fourth meshes from the currents flowing in the cells thereof and the voltages induced in the cells thereof in response to the application of the exemplary bias to the geometry. The means for coupling can further couple the circuit model for the combination of the third and fourth meshes with the circuit models of the first and second meshes to form the composite terminal circuit model for the geometry.

When the geometry includes a conductor disposed through the aperture in spaced, non-contacting relation: the first mesh includes a subset of cells for that portion of the conductor that extends in a direction opposite the second side; the second mesh includes a subset of cells for that portion of the conductor that extends in a direction opposite the first side; the third mesh includes a subset of cells for that portion of the conductor that resides in the aperture; and the fourth mesh includes a subset of cells for that portion of the conductor that resides in the aperture.

Each circuit model can be an S-parameter circuit model.

Another embodiment of the invention is a computer readable medium having stored thereon instructions which, when executed by a processor, cause the processor to perform the steps of: (a) discretize first and second sides of an analytical model of a 3D geometry into first and second surface and/or volume meshes; (b) determine for each mesh a current that flows in each cell thereof in response to the application of an exemplary bias to the geometry; (c) determine for each mesh a voltage induced in each cell thereof in response to the application of the exemplary bias to the geometry; (d) for each mesh, determine from the currents flowing in the cells thereof and the voltages induced in the cells thereof a corresponding circuit model; and (e) combine the circuit models of the meshes to form a composite circuit model for the geometry.

When the geometry includes an aperture therethrough, the instructions can further cause the processor to perform the step of discretizing the first and second sides of the analytical model of the geometry into third and fourth surface and/or a volume meshes each of which includes no cells at a location thereof corresponding to the location of the aperture in the geometry.

The instructions can further cause the processor to perform the steps of: determine for the combination of the third and fourth meshes from the currents flowing in the cells thereof and the voltages induced in the cells thereof in response to the application of the exemplary bias to the geometry a corresponding circuit model; and combine the circuit model for the combination of the third and fourth meshes with the circuit models of the first and second meshes to form the composite terminal circuit model for the geometry.

When the geometry includes a conductor disposed through the aperture in spaced, non-contacting relation, the instructions further cause the processor to perform the steps of: cause the first mesh to include a subset of cells for that portion of the conductor that extends in a direction opposite the second side; cause the second mesh to include a subset of cells for that portion of the conductor that extends in a direction opposite the first side; cause the third mesh to include a subset of cells for that portion of the conductor that resides in the aperture; and cause the fourth mesh to include a subset of cells for that portion of the conductor that resides in the aperture.

### BRIEF DESCRIPTION OF THE DRAWINGS

FIG. 1 is a block diagram of an exemplary computer system capable of implementing an embodiment of the present invention, including a computer readable storage medium for storing computer readable program code that cause the microprocessor of the computer system to perform the steps of the method;

FIG. 2 is a perspective view of a length of a waveguide including a section (shown in phantom) to be analyzed in accordance an embodiment of the present invention;

FIG. 3 is a perspective view of a pair of meshes corresponding to the outside and inside surfaces of the section of the waveguide shown in phantom in FIG. 2;

FIG. 4 is a block diagram of the S-parameter circuit models of the meshes shown in FIG. 3, including the connection thereof to each other to form a composite circuit model;

FIG. 5 is a perspective view of another length of a waveguide including therein an aperture through which a wire projects in non-contacting relation, the waveguide including a section (shown in phantom) to be analyzed in accordance an embodiment of the present invention;

FIG. 6 is a perspective view of a first pair of meshes corresponding to the inside and outside surfaces of the waveguide shown in FIG. 5, including mesh models of the wire projecting through the aperture of the waveguide, along with a second pair of meshes, each of which includes a model of the aperture absent mesh elements along with a model of the projection of the wire through aperture, wherein said projection of the wire includes mesh elements; and

FIG. 7 is a block diagram of S-parameter circuit models corresponding the inside and outside surfaces of the waveguide shown in FIG. 5 and an S-parameter circuit model for the second pair of meshes that include the model of the aperture and the segment of the wire that projects therethrough.

### DETAILED DESCRIPTION OF THE INVENTION

The present invention will be described with reference to the accompanying figures where like reference numbers correspond to like elements.

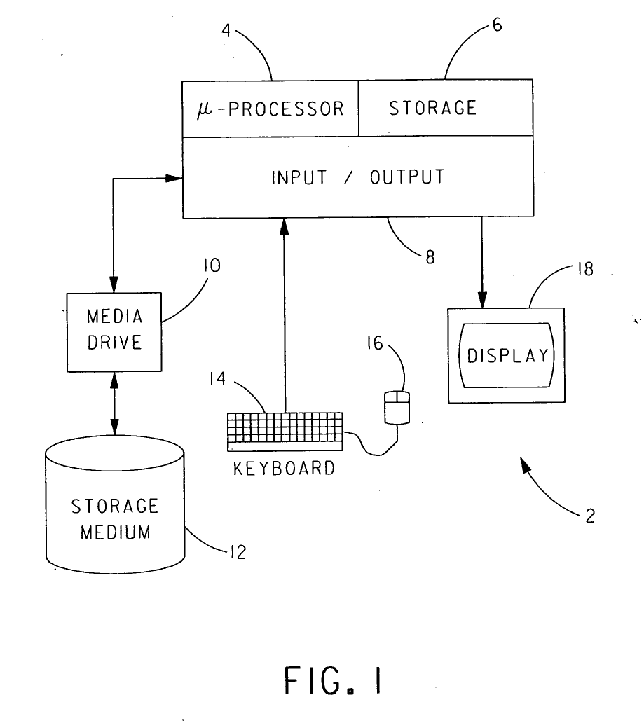

With reference to FIG. 1, the present invention is embodied in computer readable program code which executes on one or more computer systems 2. Each computer system 2 includes a microprocessor 4, a computer storage 6 and an input/output system 8. Each computer system 2 also includes a media drive 10, such as a disk drive, a CD ROM drive, and the like. Media drive 10 can be operated under the control of the computer readable program code that resides in a computer readable storage medium 12. The computer readable program code is able to configure and operate computer system 2 in a manner to implement the present invention.

Input/output system 8 can include a keyboard 14, a mouse 16 and/or a display means 18, such as a video monitor, a printer or any other suitable and/or desirable display means for providing a visually perceptible image. Computer system 2 is exemplary of computer system(s) capable of executing the computer readable program code of the present invention and is not to be construed as limiting the invention.

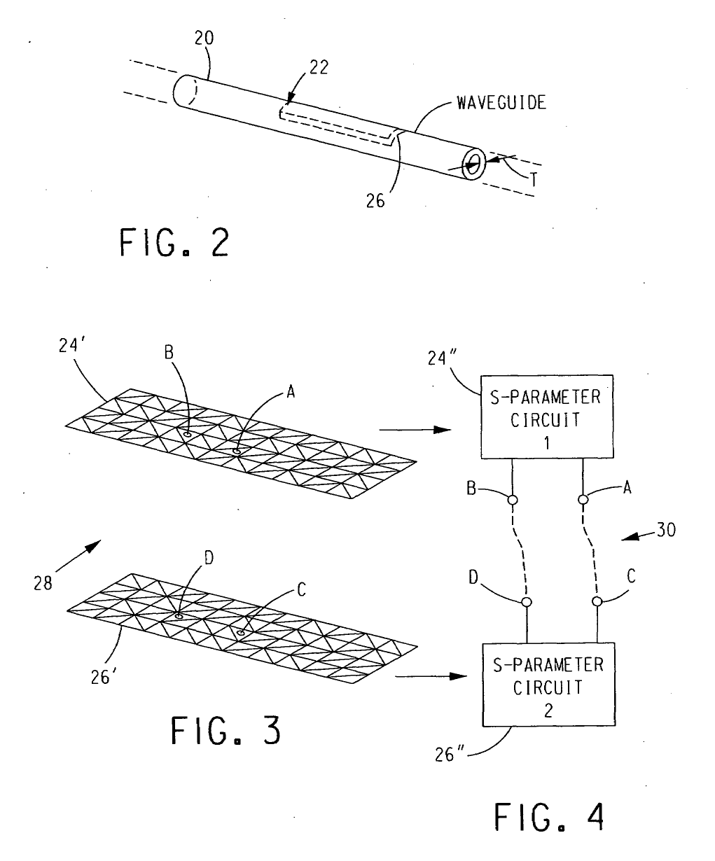

With reference to FIG. 2, an embodiment of the present invention will now be described with reference to a length of a waveguide 20 having a thickness T. The length of waveguide 20 shown in FIG. 2 can be the entirety of the waveguide or can be a subset of a larger length of waveguide. Accordingly, the length of waveguide 20 shown in FIG. 2 is not to be construed as limiting the invention. Moreover, the description of the present invention in connection with waveguide 20 is not to be construed as limiting the invention since it is envisioned that the present invention is usable in connection with any device or object having a 3D geometry that is capable of carrying current, e.g., IC packages, circuit boards, integrated circuits, electrical connectors, aircrafts, automobiles, antennas, humans, biological systems, etc.

With reference to FIG. 3 and with continuing reference to FIG. 2, a section 22 (shown in phantom) of waveguide 20 shown in FIG. 2 is selected for the purpose of describing the present invention. However, this is not to be construed as limiting the invention since it is envisioned that any suitable and/or desirable section of waveguide 20 can also or alternatively be selected. Because waveguide 20 has a thickness T, section 22 of waveguide 20 has a first, outside surface 24 and a second, inside surface 26 (shown in phantom).

With reference to FIG. 3 and with continuing reference to FIG. 2, next, an analytical model of the 3D geometry of section 22 is formed in (input into) computer system 2. Outside surface 24 and inside surface 26 of this analytical model 28 are then discretized by computer system 2 into a first, outside surface and/or volume mesh 24′ and a second, inside surface and/or volume mesh.

In FIG. 3, first and second meshes 24′ and 26′ are shown as two dimensional surfaces. However, this is not to be construed as limiting the invention since it is envisioned that one or both of first and second meshes 24′ and 26′ can also or alternatively have a thickness whereupon said mesh(es) is a so-called volume mesh.

In FIG. 2, section 22 is shown as having a curved surface in the direction of the circumference of waveguide 20. In contrast, FIG. 3 illustrates first and second meshes 24′ and 26′ as flat surfaces. The illustration in FIG. 2 of section 22 having a curved surface and the illustration in FIG. 3 of first and second meshes being flat are not to be construed as limiting the invention since it is envisioned that first and second meshes can have any suitable and/or desirable shape deemed suitable by one of ordinary skill in the art to facilitate modeling of the 3D geometry of section 22 in the manner described in greater detail hereinafter. Similarly, the following discussion of modeling is not to be construed as limited to the curved surface of section 22 since it is envisioned that said modeling can occur on a volume having any suitable and/or desirable shape.

Next, for each mesh 24′ and 26′ a current that flows in each cell thereof and a voltage induced in each cell thereof in response to the application of an exemplary bias to the geometry is determined. This is generally accomplished by solving Maxwell's equations for meshes 24′ and 26′ independently. For example, the current that flows and the voltage induced in each cell of mesh 24′ is determined by solving Maxwell's equations for mesh 24′. Similarly, the current that flows and the voltage induced in each cell of mesh 26′ is determined by solving Maxwell's equation for mesh 26′.

Next, for each mesh 24′ and 26′, a circuit model of the mesh and, hence, the corresponding side or volume of section 22, is determined from the currents flowing in the cells thereof and the voltages induced in the cells thereof.

The current model for each mesh 24′ and 26′ can be determined either via a direct simulation technique or an iterative solution technique. The direct simulation technique includes converting Maxwell's equations for each mesh into a matrix equation commonly known as the method of moments matrix. This matrix is then inverted in a process known as matrix inversion to yield a unit matrix from which an equivalent circuit model can be determined in the manner known in the art.

In contrast to the direct simulation technique discussed above, the iterative solution technique includes iteratively determining a solution for matrix x in the equation Ax=b, where A is a matrix determined from the currents flowing and the voltages induced in the cells of the mesh and b is an (n×1) vector matrix of the voltages determined for each cell of the mesh. The matrix A utilized by the iterative solution technique can be determined either be a method of moments matrix or a compressed (preconditioned) version of the method of moments matrix determined by one or more of the following methods: a fast multi-pole technique, a singular values decomposition technique, a QR decomposition technique, an adaptive cross approximation technique, a fast Fourier transform technique, a wavelet technique, or some combination of two or more of these techniques. Once matrix x has been determined for the equation Ax=b; an equivalent circuit model corresponding to the matrix can be determined from matrix x in a manner known in the art.

Thus, as can be seen, an equivalent circuit model can be determined for each mesh 24′ and 26′ either by way of a direct simulation technique or an iterative solution technique as deemed suitable and/or desirable by one of ordinary skill in the art.

Once an equivalent circuit model has been determined for each mesh 24′ and 26′, the circuit model can be converted utilizing conventional techniques to a scattering parameters or S-parameters circuit model in a manner known in the art. In anticipation of coupling the S-parameter circuit model for each mesh 24′ and 26′ to each other, two nodes in two cells of each mesh are identified prior to determining the circuit model for the mesh. In FIG. 3, mesh 24′ includes nodes A and B in separate cells and mesh 26′ includes nodes C and D in separate cells. Desirably, the physical locations of the nodes in each mesh 24′ and 26′ are selected to be in alignment with each other. For example, the physical location corresponding to node A in mesh 24′ in section 22 of waveguide 20 is in alignment across the thickness T of waveguide 20 with the physical location in section 22 of waveguide 20 corresponding to node C in mesh 26′.

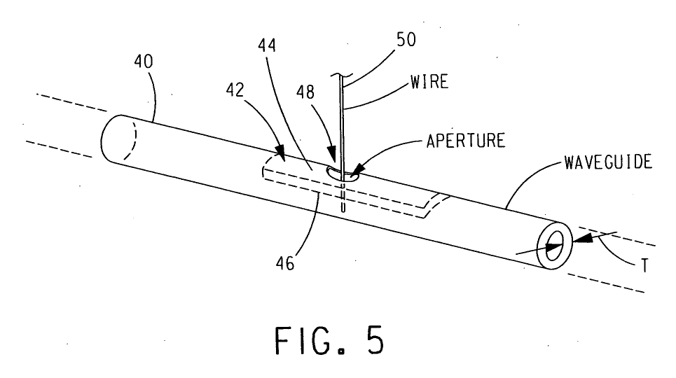

With reference to FIG. 4 and with continuing reference to FIG. 3, once an S-parameter circuit model 24″ has been determined for mesh 24′ and an S-parameter circuit model 26″ has been determined for mesh 26′, circuit models 24″ and 26″ can be coupled together by their nodes, e.g., nodes A and B of circuit model 24″ are coupled to nodes C and D, respectively, of circuit model 26″, wherein said nodes are identified on meshes 24′ and 26′ prior to determining the corresponding circuit models therefore by the direct simulation technique or the iterative solution technique.

Combining circuit models 24″ and 26″ in this manner forms a composite parameter circuit model 30 that a conventional circuit simulator can solve to determine the response of composite circuit model 30 to any suitable and/or desirable exemplary electrical bias.

With reference to FIG. 5 and with continuing reference to FIGS. 2-4, a variant of waveguide 20 in FIG. 2 is shown in FIG. 5 as waveguide 40 having a thickness T. Waveguide 40 includes a section 42 having an outside surface 44 and an inside surface 46 (shown in phantom). Section 42 includes an aperture 48 through which a wire 50 projects in spaced, non-contacting relation with waveguide 40. For the purpose of description, it will be assumed that the portion of wire 50 inside of waveguide 40 is also spaced from the interior of waveguide 40. However, this is not to be construed as limiting the invention.

With reference to FIG. 6 and with continuing reference to FIGS. 2-5, at a suitable time, analytical models of outside and inside surfaces 44 and 46, including the projection of wire 50 therefrom, are input in computer system 2 and are discretized thereby into a first, outside surface and/or volume mesh 44′ and second, inside surface and/or volume mesh 46′ in the same manner discussed above for meshes 24′ and 26′. In contrast to meshes 24′ and 26′, however, mesh 44′ includes a subset of cells modeling the section of wire 50 that extends from waveguide 40 in a direction away from inside surface 46 of section 42. Similarly, mesh 46′ is formed in the same manner as mesh 26′ in FIG. 3, except that mesh 46′ includes a subset of cells modeling the section of wire 50 that extends from waveguide 40 in a direction opposite outside surface 44 of section 42.

In addition to meshes 44′ and 46′, two additional meshes 44″ and 46″ are derived from the analytical model of the outside surface 44 and inside surface 46 of section 42 of waveguide 40. In contrast to meshes 44′ and 46′, however, meshes 44″ and 46″ have no cells at locations thereof corresponding to the location of aperture 48 in the geometry of section 42. However, each mesh 44″ and 46″ includes cells corresponding to the section of wire 50 that passes in non-contacting relation through aperture 48. In FIG. 6, aperture 48 in FIG. 5 is represented by references numbers 48′ associated with each mesh 44″ and 46″.

The combination of meshes 44′, 44″, 46′ and 46″ defines a discretized analytic model 54 of section 42 of waveguide 40.

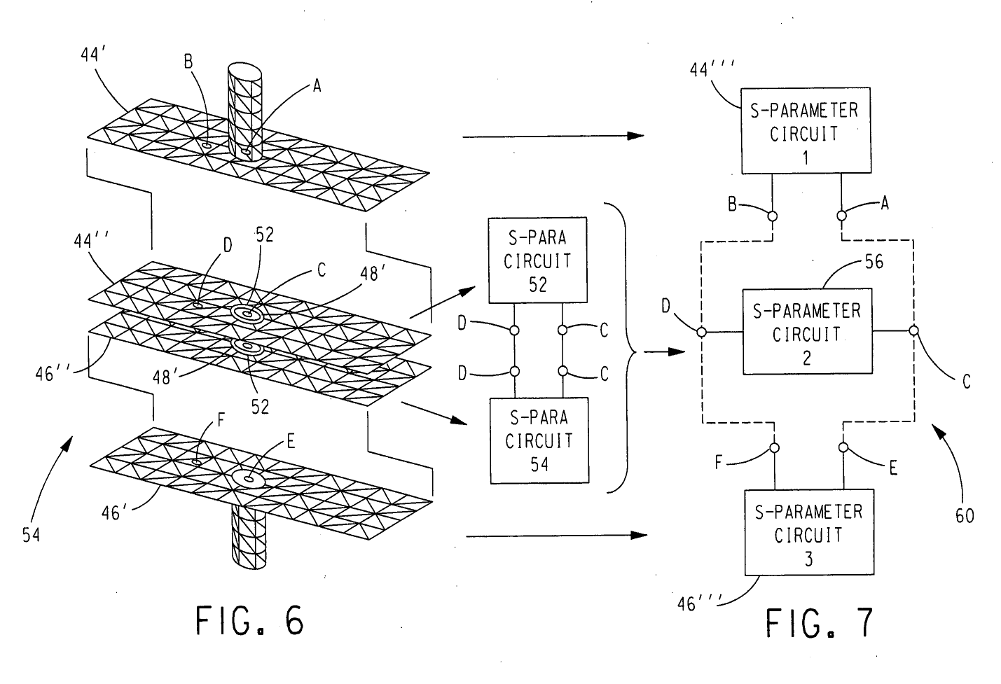

With reference to FIG. 7 and with continuing reference to all previous figures, meshes 44′ and 46′ are processed in a manner similar to meshes 24′ and 26′ in FIG. 3—taking into account the subset of cells corresponding to the section of wire 50 in each mesh 44′ and 46′—to determine S-parameter circuit models 44′″ and 46′″, respectively. In anticipation of coupling S-parameter circuit models 44′″ and 46′″ to each other, two nodes are identified in two cells of each mesh 44′ and 46′ prior to determining the circuit model for the mesh. Desirably, the location of one node of each mesh is selected to reside at a location corresponding to where wire 50 pastes through aperture 48 of section 42 of waveguide 40. In FIG. 6, these nodes are shown as node A and E. The other nodes, i.e., node B and node F, of meshes 44′ and 46′ are selected to lie at a position close to node A and node E in the discretized analytic model of top surface 44 and bottom surface 46 represented by meshes 44′ and 46′.

Next, a first intermediate S-parameter circuit model 52 is determined for mesh 44″ from the currents flowing in the cells thereof and the voltages induced in the cells thereof in response to the application of the exemplary bias. Similarly, a second intermediate S-parameter circuit model 54 is determined for mesh 46″ from the currents flowing in the cells thereof and the voltages induced in the cells thereof in response to the application of the exemplary bias. These two S-parameter circuit models 52 and 54 are joined by nodes corresponding to points C, D selected in the cells of each mesh 44″ and 46″ prior to conversion into the corresponding intermediate S-parameter circuit model. As shown in FIG. 6, node C is selected on the section 52 of wire 50 modeled by mesh 44″ and node D is selected at a point near aperture 48′ of mesh 44″. In a similar manner, nodes C and D of mesh 46″, analogous to nodes C and D on mesh 44″, are selected at the same locations on mesh 46″, as nodes C and D on mesh 44″ prior to determining the intermediate S-parameter circuit model 54 of mesh 46″. Thereafter, nodes C and D of meshes 44″ and 46″ are coupled together to form an S-parameter circuit model 56.

Once S-parameter circuit models 44′″, 46′″ and 56 have been determined, these models can be joined together by coupling their respective nodes to form a composite circuit model 60. For example, as shown in FIG. 7, nodes B, D and F of S-parameter circuit models 44′″, 56 and 46′″, respectively, are joined, and nodes A, C and E of S-parameter circuit models 44′″, 56 and 46′″, are joined to form a composite S-parameter circuit model 60. Also or alternatively, test parameter composite circuit model 60 can be formed by combining the nodes of S-parameter circuit models 44′″, 52, 54 and 46′″.

Once composite circuit model 60 has been determined, a conventional circuit simulator can solve the response of circuit model 60 to any suitable and/or desirable exemplary electrical bias. Other sections of waveguides 20 and 40, either adjacent to or remote from sections 22 and 42, can also or alternatively be modeled in the same manner discussed above, taking into account the presence or absence of a wire projecting through an aperture. The nodes of each S-parameter circuit model determined for each contiguous or non-contiguous section of each waveguide 20 and 40 can be coupled together in the manner discussed above in order to form a composite circuit model for the entirety of waveguide 20 or 40 being modeled. Thus, the embodiments discussed above are extensible to piecemeal modeling multiple sections of waveguide 20 or 40.

As can be seen, the above-described embodiments disclose piecemeal modeling of structures to determine a composite S-parameter circuit model for said structure which can then be analyzed utilizing a conventional circuit simulator to determine the response of the S-parameter circuit model and, hence, the structure to an exemplary bias applied thereto. A benefit of piecemeal modeling a structure to determine a composite S-parameter circuit model for one or more sections of the structure (or the entire structure) is that the computational inefficiencies of the prior art, wherein it was necessary to solve a large, dense matrix system, can be avoided. It is also believed that the piecemeal modeling of a structure to produce S-parameter circuit model of each section thereof results in a composite S-parameter circuit model that more accurately models the real-world response of the structure.

The foregoing embodiments were described in connection with sections 22 and 42 of waveguides 20 and 40, respectively. However, this is not to be construed as limiting the invention since it is envisioned that the above-described embodiments are extensible to modeling of the entirety of waveguides 20 and 40, albeit one or more sections at-a-time. In addition, the present invention is also extensible to structures other than waveguides 20 and 40, e.g., integrated circuits, printed circuit boards, and any other structure that is desired to model. Still further, the present embodiments are also extensible to modeling of circuit elements that are made of conductors, dielectrics and semiconductors. Accordingly, the foregoing embodiments described in connection with waveguides 20 and 40, and wire 50 in waveguide 40, made entirely from conductive material, is not to be construed as limiting the invention.

The invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A method of determining a composite circuit model of a 3D geometry, the method comprising:
(a) discretizing first and second sides of an analytical model of a 3D geometry into first and second surface and/or volume meshes;
(b) determining for each mesh a current that flows in each cell thereof in response to the application of an exemplary bias to the geometry;
(c) determining for each mesh a voltage induced in each cell thereof in response to the application of the exemplary bias to the geometry;
(d) for each mesh, determining from the currents flowing in the cells thereof and the voltages induced in the cells thereof a corresponding circuit model; and
(e) coupling the circuit models of the meshes to form a composite circuit model for the geometry.

2. The method of claim 1, wherein, in step (d), the circuit model for each mesh is determined via either a direct simulation technique or an iterative solution technique.

3. The method of claim 2, wherein:
the direct simulation technique comprises inverting a matrix of the currents flowing and the voltages induced in the cells of the mesh; and
the iterative solution technique comprises iteratively determining a solution for x in the equation Ax=b, where A is a matrix determined from the currents flowing and the voltages induced in the cells of the mesh and b is an (n×1) vector of the voltages determined for each cell of the mesh in step (c).

4. The method of claim 3, wherein:
the matrix of the direct simulation technique is determined via a method of moments technique; and
the matrix A of the iterative solution technique is determined via either:
(1) the method of moments technique; or
(2) a compressed version of matrix a matrix determined via the method of moments technique.

5. The method of claim 4, wherein the compressed version of the matrix is determined via:
a fast multipole technique;
a singular value decomposition technique;
a QR decomposition technique;
an adaptive cross approximation technique;
a fast Fourier transform technique;
a wavelet technique; or
some combination of two or more thereof.

6. The method of claim 1, wherein each circuit model is an S-parameter circuit model.

7. The method of claim 1, wherein, when the geometry includes an aperture therethrough, step (a) further includes discretizing the first and second sides of the analytical model of the geometry into third and fourth surface and/or a volume meshes each of which includes no cells at a location thereof corresponding to the location of the aperture in the geometry.

8. The method of claim 7, wherein:
step (d) further includes, for the combination of the third and fourth meshes, determining from the currents flowing in the cells thereof and the voltages induced in the cells thereof in response to the application of the exemplary bias to the geometry a corresponding circuit model; and
step (e) further includes coupling the circuit model for the combination of the third and fourth meshes with the circuit models of the first and second meshes to form the composite terminal circuit model for the geometry.

9. The method of claim 8, wherein, when the geometry includes a conductor disposed through the aperture in spaced, non-contacting relation:
the first mesh includes a subset of cells for that portion of the conductor that extends in a direction opposite the second side;
the second mesh includes a subset of cells for that portion of the conductor that extends in a direction opposite the first side;
the third mesh includes a subset of cells for that portion of the conductor that resides in the aperture; and
the fourth mesh includes a subset of cells for that portion of the conductor that resides in the aperture.

10. The method of claim 9, wherein each circuit model is an S-parameter circuit model.

11. A system for determining a composite circuit model of a 3D geometry, the system comprising:
means for discretizing first and second sides of an analytical model of a 3D geometry into first and second surface and/or volume meshes;
means for determining for each mesh a current that flows in each cell thereof in response to the application of an exemplary bias to the geometry;
means for determining for each mesh a voltage induced in each cell thereof in response to the application of the exemplary bias to the geometry;
means for determining for each mesh from the currents flowing in the cells thereof and the voltages induced in the cells thereof a corresponding circuit model; and
means for coupling the circuit models of the first and second meshes to form a composite circuit model for the geometry.

12. The method of claim 11, wherein the circuit model for each mesh is determined via either:
a direct simulation technique that includes inverting a matrix of the currents flowing and the voltages induced in the cells of the mesh; or
an iterative solution technique that includes iteratively solving the equation Ax b for x, wherein A is a matrix determined from the currents flowing and the voltages induced in the cells of the mesh and b is an (n×1) vector of the voltages determined for each cell of the mesh in step (c).

13. The method of claim 12, wherein:
the matrix of the direct simulation technique is determined via a method of moments technique; and
the matrix A of the iterative solution technique is determined via either:
(1) the method of moments technique; or
(2) a compressed version of a matrix determined via the method of moments technique.

14. The method of claim 13, wherein the compressed version of the matrix is determined via:
a fast multipole technique;
a singular value decomposition technique;
a QR decomposition technique;
an adaptive cross approximation technique;
a fast Fourier transform technique;
a wavelet technique; or
some combination of two or more thereof.

15. The method of claim 11, wherein each circuit model is an S-parameter circuit model.

16. The method of claim 11, wherein, when the geometry includes an aperture therethrough, the means for discretizing discretizes the first and second sides of the analytical model of the geometry into third and fourth surface and/or a volume meshes, each of which includes no cells at a location thereof corresponding to the location of the aperture in the geometry.

17. The method of claim 16, wherein:
the means for determining determines a circuit model for the combination of the third and fourth meshes from the currents flowing in the cells thereof and the voltages induced in the cells thereof in response to the application of the exemplary bias to the geometry; and
the means for coupling further couples the circuit model for the combination of the third and fourth meshes with the circuit models of the first and second meshes to form the composite terminal circuit model for the geometry.

18. The method of claim 16, wherein, when the geometry includes a conductor disposed through the aperture in spaced, non-contacting relation:
the first mesh includes a subset of cells for that portion of the conductor that extends in a direction opposite the second side;
the second mesh includes a subset of cells for that portion of the conductor that extends in a direction opposite the first side;
the third mesh includes a subset of cells for that portion of the conductor that resides in the aperture; and
the fourth mesh includes a subset of cells for that portion of the conductor that resides in the aperture.

19. The method of claim 18 wherein each circuit model is an S-parameter circuit model.

20. A computer readable medium having stored thereon instructions which, when executed by a processor, cause the processor to perform the steps of:
(a) discretize first and second sides of an analytical model of a 3D geometry into first and second surface and/or volume meshes;
(b) determine for each mesh a current that flows in each cell thereof in response to the application of an exemplary bias to the geometry;
(c) determine for each mesh a voltage induced in each cell thereof in response to the application of the exemplary bias to the geometry;
(d) for each mesh, determine from the currents flowing in the cells thereof and the voltages induced in the cells thereof a corresponding circuit model; and
(e) combine the circuit models of the meshes to form a composite circuit model for the geometry.

21. The computer readable medium of claim 20, wherein, when the geometry includes an aperture therethrough, the instructions further cause the processor to perform the step of discretizing the first and second sides of the analytical model of the geometry into third and fourth surface and/or a volume meshes each of which includes no cells at a location thereof corresponding to the location of the aperture in the geometry.

22. The method of claim 21, wherein the instructions further cause the processor to perform the steps of:
determine for the combination of the third and fourth meshes from the currents flowing in the cells thereof and the voltages induced in the cells thereof in response to the application of the exemplary bias to the geometry a corresponding circuit model; and
combine the circuit model for the combination of the third and fourth meshes with the circuit models of the first and second meshes to form the composite terminal circuit model for the geometry.

23. The computer readable medium of claim 21, wherein, when the geometry includes a conductor disposed through the aperture in spaced, non-contacting relation, the instructions further cause the processor to perform the steps of:
cause the first mesh to include a subset of cells for that portion of the conductor that extends in a direction opposite the second side;
cause the second mesh to include a subset of cells for that portion of the conductor that extends in a direction opposite the first side;
cause the third mesh to include a subset of cells for that portion of the conductor that resides in the aperture; and
cause the fourth mesh to include a subset of cells for that portion of the conductor that resides in the aperture.
